(19) United States
(12) Patent Application Publication
(10) Pub. No.: US 2010/0324753 A1
(43) Pub. Date: Dec. 23, 2010

(54) VEHICLE, SYSTEM INCLUDING THE SAME, VEHICLE MOTION PRODUCING METHOD

(75) Inventor: Yoshihiro OKUMATSU, Toyota-shi (JP)

Correspondence Address: KENYON & KENYON LLP, 1500 K STREET N.W., SUITE 700, WASHINGTON, DC, 20005, US

(73) Assignee: TOYOTA JIDOSHA KABUSHIKI KAISHA, Toyota-shi (JP)

(21) Appl. No.: 12/816,582

(22) Filed: Jun. 16, 2010

(30) Foreign Application Priority Data
Jun. 17, 2009 (JP) 2009-144083

(51) Int. Cl. G06F 19/00

(52) U.S. Cl. 701/2

(57) ABSTRACT

A robot executes motion by modifying a motion behavior on the basis of a motion direction of a user on board according to a state of mind of the user on board. This produces the motion of the vehicle under conditions that reflect the user's state of mind. The robot preferably includes a direction input portion that receives the motion direction from the user and generates a reference input corresponding to the motion direction, and an inverted control reference input generator that generates a motion reference input that makes the robot execute motion in a behavior different from the motion behavior on the basis of the motion direction, based at least on a reduction coefficient with a value corresponding to the user's state of mind and the reference input generated in the direction input portion. The reduction coefficient is determined by measuring the pulse rate of the user on board.

### INCORPORATION BY REFERENCE

This application is based upon and claims the benefit of priority from Japanese patent application No. 2009-144083, filed on Jun. 17, 2009, the disclosure of which is incorporated herein in its entirety by reference.

### BACKGROUND OF THE INVENTION

1. Field of the Invention

The present invention relates to a vehicle, a system including the same, a vehicle motion producing method, and a program storage medium.

2. Description of Related Art

Recently, technology related to robots used for the spatial movement of humans has become significantly advanced with development of robot technology. For a moving robot, stability and safety during movement are strongly demanded. In order to ensure the stability and safety during movement of a robot, it is strongly demanded to execute posture control of a robot with high accuracy based on inputs of various sensors. A body of a robot that functions as a vehicle has various kinds of built-in electrical/mechanical components such as various sensors, a microcomputer, a power supply and a linkage.

Japanese Unexamined Patent Application Publication No. 2000-116718 discloses a wheelchair capable of keeping the safe and comfortable posture even in a steeply inclined area or on an irregular ground surface. The disclosed technique prevents a user of the wheelchair from having a feeling of anxiety by maintaining the seat substantially in the horizontal position. Japanese Unexamined Patent Application Publication No. 2004-149035 discloses a tracking travel control device for a vehicle. When a driver feels psychological pressure from an object, a target value determination portion and a vehicle state control portion make control of the distance between vehicles in consideration of reducing acceleration control.

When a user on board a vehicle maneuvers the vehicle, there is a case where the vehicle executes motion in a different way from what is intended by the user. For example, there is a case where the user feels anxiety about the vehicle because the vehicle starts moving with a higher speed than expected. There is also a case where the user feels anxiety about the vehicle because the vehicle corners at a higher speed than expected. If a deviation occurs between the user's sense of maneuvering and the actual motion of a vehicle, there is a possibility that the user can have a feeling of anxiety against traveling on board the vehicle.

It should be noted that the user's sense of maneuvering is unique to each individual user. For example, the sense of maneuvering can be different depending on the age of users. Further, even in the same person, a sense of maneuvering at the present moment can be different from a sense of maneuvering at the past moment depending on the physical condition and the psychological condition during maneuvers.

As is obvious from the above description, it is strongly demanded to produce the motion of a vehicle under conditions that reflect the state of mind of a user.

### SUMMARY OF THE INVENTION

A first exemplary aspect of the present invention is a vehicle that executes motion by modifying motion based on a motion direction of a user on board according to the state of mind of the user on board. It is thereby possible to produce the motion of the vehicle under conditions that reflect the state of mind of the user.

The vehicle preferably includes a direction input portion that receives the motion direction from the user and generates a reference input corresponding to the motion direction, and a motion reference input generator that generates a motion reference input that makes the vehicle execute motion in a behavior different from the motion behavior on the basis of the motion direction, based at least on a state value with a value corresponding to the state of mind of the user and the reference input generated in the direction input portion.

It is preferred that the state value is determined based on measurement of a physical state of the user on board. This enables estimation of the state of mind of the user with high accuracy.

The vehicle preferably further includes a sensor that measures a physical state of the user on board and a state value generator that generates the state value based on an output of the sensor.

It is preferred that the state value generator generates the state value based on an evaluation value generated by evaluating the physical state of the user measured by the sensor.

It is further preferred that the state value generator generates the state value based on an identification value assigned to each user in addition to the evaluation value.

It is also preferred that the state value generator searches for information by using the evaluation value and the identification value as a search key and sets a value found by searching to the state value.

It is also preferred that the state value generator reevaluates the physical state of the user when the vehicle is executing motion by modifying the motion behavior on the basis of the motion direction of the user, and updates a value of the state value generated by the state value generator under identical conditions based on the reevaluation result.

It is also preferred that the motion reference input generator generates a motion reference input for making the vehicle execute motion to improve the state of mind of the user when the state value is generated by the state value generator during a period when the vehicle is not moving.

The vehicle is preferably a vehicle that moves through a space with a position of a body relative to a wheel being controlled.

The vehicle preferably further includes an angular speed sensor that measures an angular speed of the body, and a measuring portion that measures a change in a relative position between the body and the wheel in a rotating direction of the wheel, and the motion reference input generator preferably generates the motion reference input based on the state value, the reference input generated in the direction input portion, an output of the angular speed sensor, and an output of the measuring portion.

A second exemplary aspect of the present invention is a system which includes a plurality of vehicles each including a direction input portion that receives a motion direction from a user and generates a reference input corresponding to the motion direction and a sensor that measures a physical state of the user on board, and an information processing device connected for communicating with each of the plurality of vehicles in an identifiable manner, wherein the information processing device generates a state value with a value corresponding to a state of mind of the user based an output of the sensor, and each vehicle executes motion by modifying a motion behavior on the basis of the motion direction, based at least on the state value transmitted from the information processing device to the vehicle and the reference input generated in the direction input portion.

A third exemplary aspect of the present invention is a vehicle motion producing method that includes measuring a physical state of a user on board a vehicle in order to estimate a state of mind of the user, and modifying a motion behavior of the vehicle on the basis of a motion direction directed to the vehicle by the user according to a measurement result of the physical state of the user.

A fourth exemplary aspect of the present invention is a non-transitory computer readable medium storing a program causing a computer to execute a process that modifies a motion behavior of a vehicle on the basis of a motion direction directed to the vehicle by a user on board the vehicle according to a measurement result of a physical state of the user.

According to the exemplary aspects of the present invention described above, it is possible to produce the motion of a vehicle under conditions that reflect the state of mind of a user.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a schematic perspective view of an inverted two-wheeled robot according to a first exemplary embodiment of the present invention;

FIG. 2 is a schematic block diagram of the inverted two-wheeled robot according to the first exemplary embodiment of the present invention;

FIG. 3 is an explanatory view showing an overview of anxiety reduction control according to the first exemplary embodiment of the present invention;

FIG. 4 is an explanatory view showing a structure of a table according to the first exemplary embodiment of the present invention;

FIG. 5 is an explanatory view showing an overview of anxiety reduction control according to the first exemplary embodiment of the present invention;

FIG. 6 is a schematic flowchart showing the motion of the inverted two-wheeled robot according to the first exemplary embodiment of the present invention;

FIG. 7 is a schematic flowchart showing the motion of the inverted two-wheeled robot according to the first exemplary embodiment of the present invention;

FIG. 8 is a schematic flowchart showing the motion of the inverted two-wheeled robot according to the first exemplary embodiment of the present invention;

FIG. 9 is a schematic block diagram of an inverted two-wheeled robot according to a second exemplary embodiment of the present invention;

FIG. 10 is a schematic block diagram of a transmit/receive portion of the inverted two-wheeled robot according to the second exemplary embodiment of the present invention;

FIG. 11 is a schematic block diagram of an inverted two-wheeled robot according to a third exemplary embodiment of the present invention;

FIG. 12 is a schematic perspective view of the inverted two-wheeled robot according to the third exemplary embodiment of the present invention;

FIG. 13 is a schematic block diagram of an inverted two-wheeled robot according to a fourth exemplary embodiment of the present invention;

FIG. 14 is a schematic perspective view of the inverted two-wheeled robot according to the fourth exemplary embodiment of the present invention;

FIG. 15 is a schematic block diagram of an inverted two-wheeled robot according to a fifth exemplary embodiment of the present invention;

FIG. 16 is a schematic perspective view of the inverted two-wheeled robot according to the fifth exemplary embodiment of the present invention;

FIG. 17 is a schematic block diagram of an inverted two-wheeled robot according to a sixth exemplary embodiment of the present invention;

FIG. 18 is a schematic block diagram of an inverted two-wheeled robot according to a seventh exemplary embodiment of the present invention;

FIG. 19 is a schematic explanatory view showing the motion of an inverted two-wheeled robot according to an eighth exemplary embodiment of the present invention; and

FIG. 20 is a schematic side view of an inverted two-wheeled robot according to a ninth exemplary embodiment of the present invention.

### DESCRIPTION OF THE EXEMPLARY EMBODIMENTS

Exemplary embodiments of the present invention are described hereinafter with reference to the drawings. Each embodiment is simplified for convenience of description. The drawings are given in simplified form by way of illustration only, and thus are not to be considered as limiting the present invention. The drawings are given merely for the purpose of explanation of technological matters, and they do not show the accurate scale or the like of each element shown therein. The same elements are denoted by the same reference symbols, and the redundant explanation is omitted. The terms indicating the directions, such as up, down, left and right, are used on condition that each drawing is viewed from the front.

### First Exemplary Embodiment

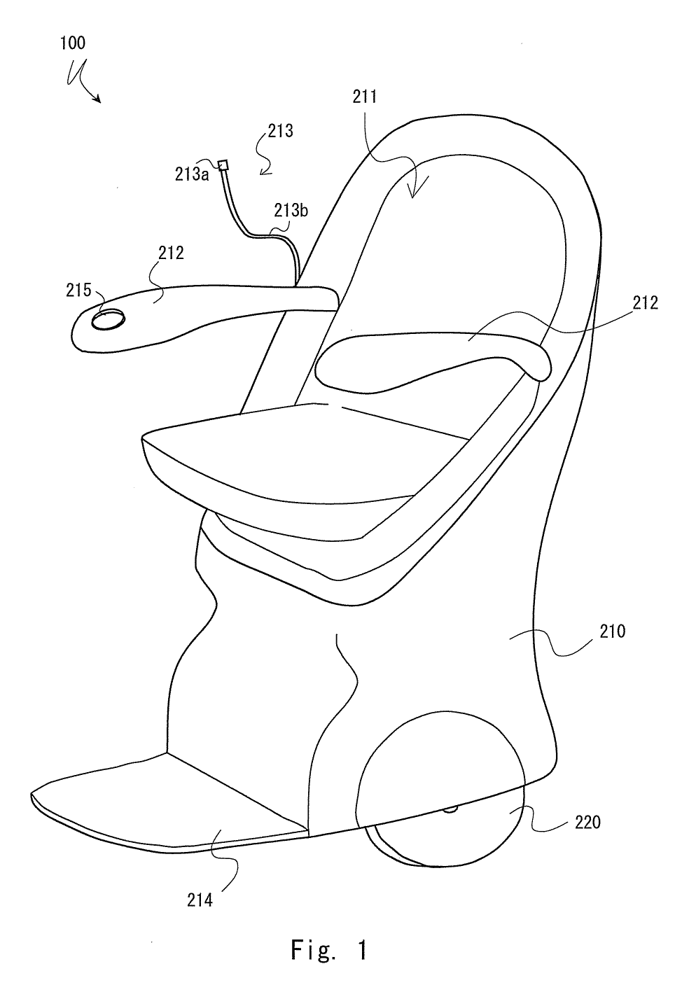

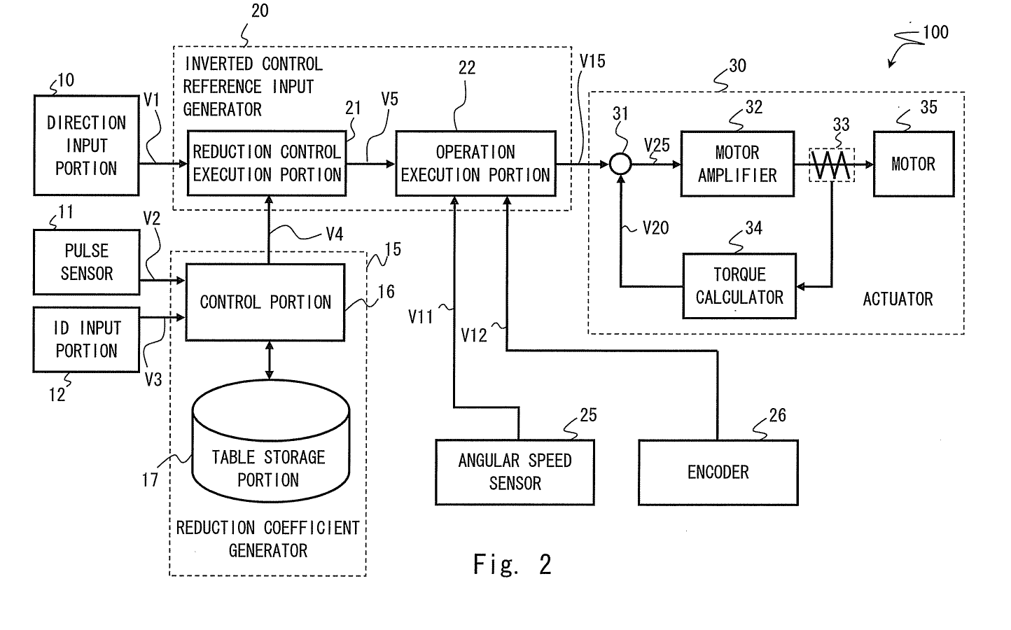

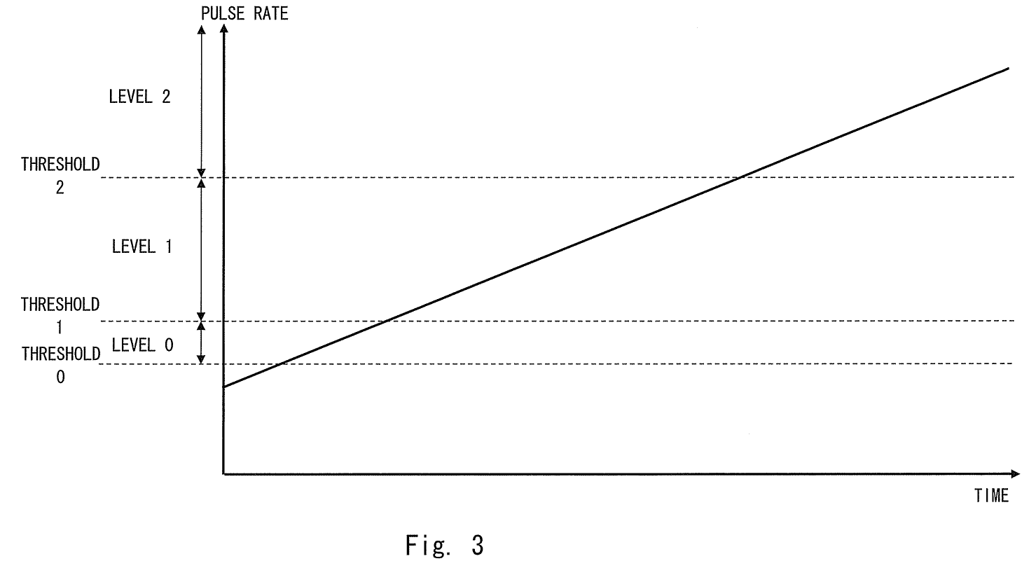

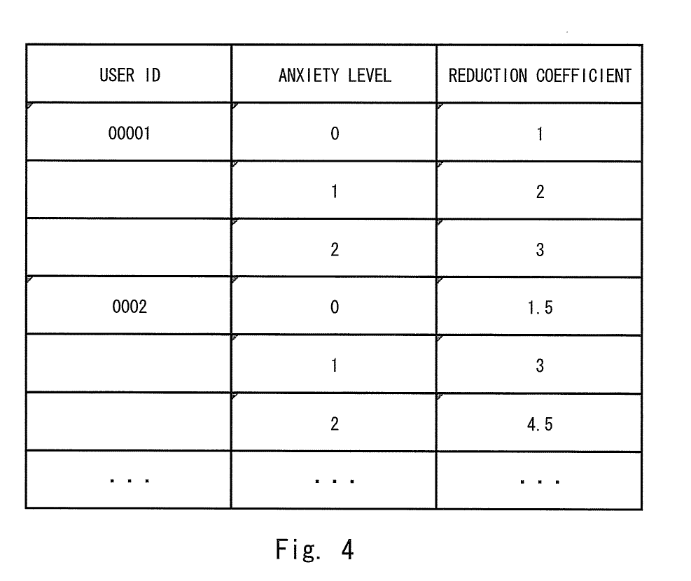

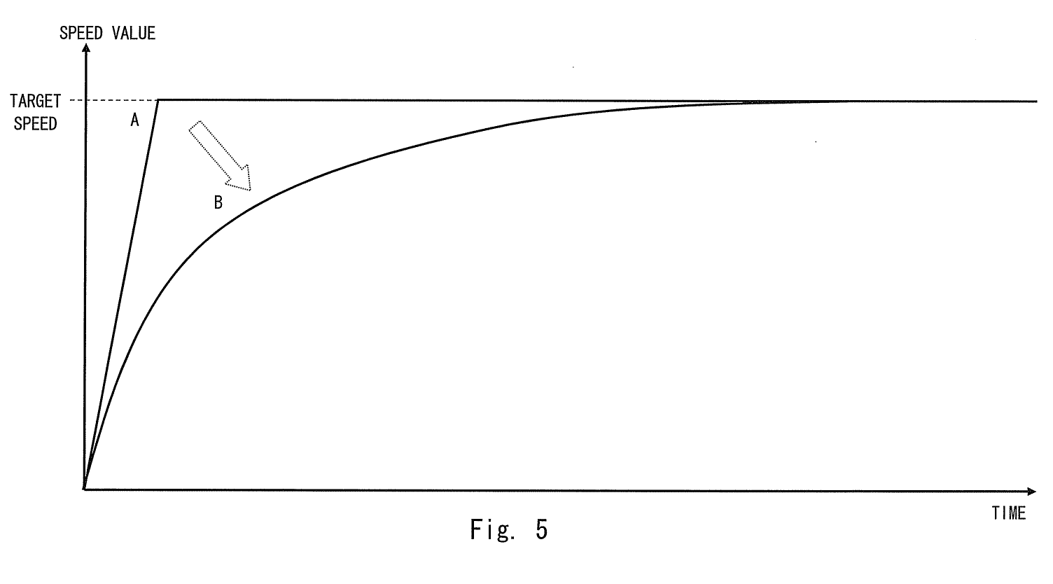

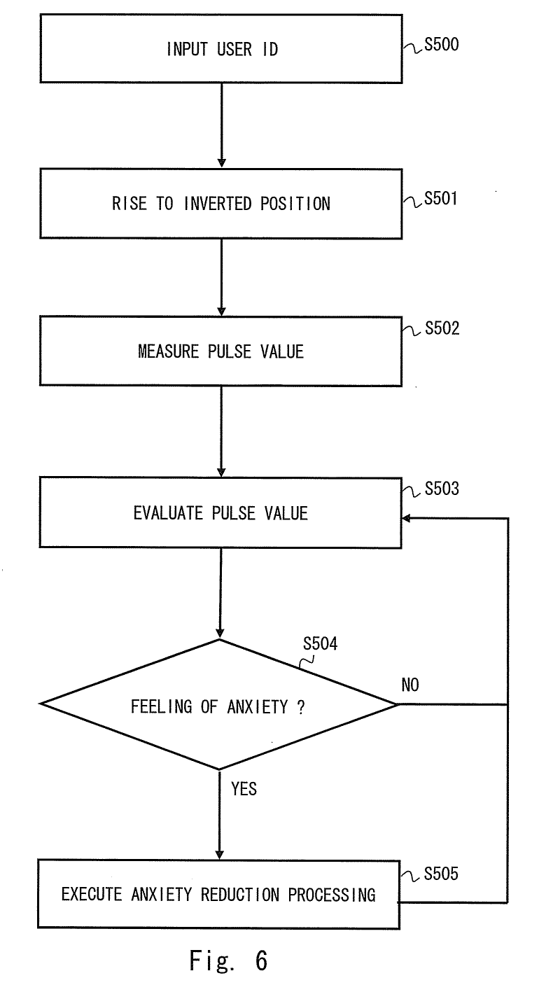

A first exemplary embodiment of the present invention is described hereinafter with reference to FIGS. 1 to 8. FIG. 1 is a schematic perspective view of an inverted two-wheeled robot. FIG. 2 is a schematic block diagram of the inverted two-wheeled robot. FIG. 3 is an explanatory view showing an overview of anxiety reduction control. FIG. 4 is an explanatory view showing a structure of a table. FIG. 5 is an explanatory view showing an overview of anxiety reduction control. FIGS. 6 to 8 are schematic flowcharts showing the motion of the inverted two-wheeled robot.

Referring to FIG. 1, an inverted two-wheeled robot 100 includes a body 210 and a wheel 220. The body 210 includes a seat 211, a pair of armrests 212, a sensor unit 213, and a footrest 214. A ball controller 215 is placed at the end of the armrest 212. The sensor unit 213 is made up of a sensor part 213a and a wire part 213b. The body 210 has various kinds of built-in electrical/mechanical components such as various sensors, a microcomputer, a power supply and a linkage.

A user of the inverted two-wheeled robot 100 (which is referred to simply as a robot 100 in some cases below) operates the ball controller 215 while seated on the seat 211. The robot 100 executes motion according to the operation of the ball controller 215 by the user. For example, if the user rotates the ball controller 215 forward, the robot 100 moves forward while maintaining the inverted position. Further, if the user rotates the ball controller 215 rightward, the robot 100 rotates rightward on the spot while maintaining the inverted position. Note that the robot 100 automatically comes into the inverted position upon switching on a start switch by a user.

The user maneuvers the robot 100 with the sensor part 213a of the sensor unit 213 attached to his/her body. In this exemplary embodiment, the sensor unit 213 measures the user's pulse per unit time (which is referred to hereinafter simply as a pulse rate). According to a pulse value corresponding to the user's pulse rate measured by the sensor unit 213, the robot 100 modifies the motion on the basis of descriptions of a motion reference input that is output from the ball controller 215. By modifying the motion of the robot 100 according to the state of mind of the user at the present moment, it is possible to produce the motion of the robot 100 under conditions that reflect the state of mind of the user. Note that the pulse is generated by heartbeat, and the both may be regarded as synonymous.

For example, if a user feels anxiety about sudden acceleration of the robot 100, control for reducing the acceleration is executed in the robot 100. By reducing the acceleration of the robot 100, the user's feeling of anxiety is eased. In this manner, it is possible to allow the actual motion of the robot to be consistent with an expectation of a user and thereby increase the level of satisfaction of the user for traveling with the robot 100. Further, by automatic control such as reducing the acceleration, it is possible to easily make time needed for operation to avoid the danger.

The ball controller 215 is, as is well known, a controller that adopts a ball as an operator. By virtue of the adoption of the ball controller 215, a user can maneuver the robot 100 simply by operating the ball by hand. The adoption of the operator that is easily operational improves the usability of the robot 100. This enables effective use of the robot 100 particularly at the time of moving a short distance.

However, a user of the robot 100 is unaccustomed to operating the ball controller 215 in some cases. In such cases, the robot 100 can execute motion in a different way from what is intended by the user of robot 100. If a deviation occurs between the user's sense of maneuvering and the actual motion of the robot 100, there is a possibility that a user can feel anxiety about moving on board the robot 100.

In this exemplary embodiment, the robot 100 modifies the motion on the basis of descriptions of a motion reference input that is output from the ball controller 215 according to a pulse value corresponding to the user's pulse rate measured by the sensor unit 213. As a result that the behavior of the robot 100 on the basis of an operation direction of a user is modified according to the state of mind of the user, it is possible to produce the motion of the robot 100 under conditions that reflect the state of mind of the user even when adopting an unaccustomed type of controller. This prevents a deviation from occurring between the user's sense of maneuvering and the actual motion of the robot 100, thereby avoiding that a user feels anxiety about moving on board the robot 100.

The robot 100 shown in FIG. 1 has a pair of coaxially arranged wheels 220. A motor corresponding to each wheel is connected to the respective wheels 220. The robot 100 controls the rotation of the motor and thereby controls the position of the body 210 with respect to the wheel 220 and moves through the space with the inverted position.

Referring next to FIG. 2, a structure of the robot 100 is described.

As shown in FIG. 2, the robot 100 includes a direction input portion 10, a pulse sensor (sensor) 11, an ID input portion 12, a reduction coefficient generator (state value generator) 15, an inverted control reference input generator 20, an angular speed sensor 25, an encoder 26, and an actuator 30. The reduction coefficient generator 15 includes a control portion 16 and a table storage portion 17. The inverted control reference input generator 20 includes a reduction control execution portion 21 and an operation execution portion 22. The actuator 30 includes an adder 31, a motor amplifier 32, a shunt resistor 33, a torque calculator 34, and a motor 35. The control portion 16 and the inverted control reference input generator 20 are constructed by software, not hardware. Specifically, they are implemented by executing a stored program on a CPU by utilizing a computer.

The connection relation among the component elements shown in FIG. 1 is described firstly. An output terminal of the direction input portion 10 is connected to an input terminal of the reduction control execution portion 21. An output terminal of the pulse sensor 11 is connected to an input terminal of the control portion 16. An output terminal of the ID input portion 12 is connected to the input terminal of the control portion 16. The control portion 16 and the table storage portion 17 are configured so that they can exchange input and output with each other. An output of the control portion 16 is supplied to the reduction control execution portion 21. An output of the reduction control execution portion 21 is supplied to the operation execution portion 22. An output terminal of the angular speed sensor 25 is connected to an input terminal of the operation execution portion 22. An output terminal of the encoder 26 is connected to the input terminal of the operation execution portion 22. An output terminal of the operation execution portion 22 is connected to an input terminal of the adder 31. An output terminal of the adder 31 is connected to an input terminal of the motor amplifier 32. An output terminal of the motor amplifier 32 is connected to an input terminal of the motor 35. The shunt resistor 33 is connected between the motor amplifier 32 and the motor 35. An input terminal of the torque calculator 34 is connected to the shunt resistor 33. An output terminal of the torque calculator 34 is connected to an input terminal of the adder 31.

The direction input portion 10 receives an input of an operation direction of a person who maneuvers the robot 100 and generates a reference input V1 corresponding to the input operation direction. The reference input V1 generated in the direction input portion 10 is transmitted to the reduction control execution portion 21. The direction input portion 10 corresponds to the ball controller 215 shown in FIG. 1. Note that, in this exemplary embodiment, each value exemplified by the reference input V1 is a digital value.

The pulse sensor 11 measures a pulse rate of a user of the robot 100 and outputs a pulse value V2 having a value corresponding to the pulse rate to the control portion 16. A method of measuring a pulse rate is arbitrary. For example, a pulse rate may be measured by an optical means that measures a blood flow amount as a reflected light amount. In this case, a band or the like to which an optical sensor is attached may be prepared so that the optical sensor is placed at a position such as the wrist or ankle of a user. Instead of the optical means, a pulse rate may be measured by another means (measurement of a potential, measurement of a pressure etc.).

The ID input portion 12 receives an input of a user ID which is assigned to each user and outputs the input user ID as a user ID value V3 to the control portion 16. A specific configuration of the ID input portion 12 is arbitrary. The direction input portion 10 and the ID input portion 12 may be implemented by a common input device.

The reduction coefficient generator 15 generates a reduction coefficient (reduction coefficient value V4) based on the pulse value V2 and the user ID value V3. A specific operation is as follows. The control portion 16 evaluates the pulse value V2 and calculates the current anxiety level (evaluation value) of a user. Next, the control portion 16 searches a table stored in the table storage portion 17 by using the anxiety level (which is equal to an anxiety level value) obtained by evaluating the pulse value V2 and the user ID value V3 as a search key. The control portion 16 reads a reduction coefficient which is found by searching from the table stored in the table storage portion 17 and outputs the read value as the reduction coefficient value V4 to the reduction control execution portion 21. The reduction coefficient is equivalent to a state value having a value corresponding to the state of mind of a user.

Processing of evaluating the pulse value V2 that is executed in the control portion 16 is described hereinafter with reference to FIG. 3. The control portion 16 determines whether the measured pulse value V2 exceeds a threshold 2, a threshold 1 and a threshold 0 in this order. When the pulse value V2 is more than the threshold 2, the control portion 16 sets the anxiety level of a user to level 2. When the pulse value V2 is more than the threshold 1 and no more than the threshold 2, the control portion 16 sets the anxiety level of a user to level 1. When the pulse value V2 is more than the threshold 0 and no more than the threshold 1, the control portion 16 sets the anxiety level of a user to level 0. By making a comparison with the thresholds sequentially in a descending order, it is possible to execute anxiety reduction control more rapidly.

The table storage portion 17 is a memory area for storing a table. FIG. 4 shows the table stored in the table storage portion 17. As shown in FIG. 4, reduction coefficients are stored in association with a user ID assigned to each user. Each reduction coefficient associated with a specific user ID can be identified by an anxiety level. Thus, a specific reduction coefficient is found when the control portion 16 searches the table stored in the table storage portion 17 by using the user ID and the anxiety level as a search key.

The inverted control reference input generator 20 generates a reference input V15 (motion reference input) that decides an operating state of the actuator 30 based on the reference input V1, the reduction coefficient value V4, an angular speed value V11 and a count value V12. The inverted control reference input generator 20 generates the reference input V15 to be transmitted to the actuator 30 under the conditions in which a motion behavior on the basis of the reference input V1 is modified according to the reduction coefficient value V4. A specific operation is as follows.

The reduction control execution portion 21 generates a reference input V5 based on the reference input V1 and the reduction coefficient value V4. The reference input V1 is an input to direct the robot 100 to execute motion such as a forward or backward movement or a rotation.

On the other hand, the reduction coefficient value V4 is a coefficient for reducing the motion amount of the robot 100 per unit time. The reduction control execution portion 21 modifies the descriptions of the reference input V1 according to the reduction coefficient value V4. The motion of the robot 100 decided by the reference input V1 is thereby executed over a longer time period. A specific technique of reducing the anxiety of a user is arbitrary, and it is not limited to the technique of the exemplary embodiment.

The operation execution portion 22 generates the reference input V15 based on the reference input V5, the angular speed value V11 and the count value V12. The robot 100 is an inverted two-wheeled vehicle as shown in FIG. 1. Therefore, it is a prerequisite that the robot 100 maintains the inverted position while moving in accordance with a direction of a user. In order for the robot 100 to execute motion in a way corresponding to an operation direction of a user while maintaining the inverted position, the operation execution portion 22 adopts a given algorithm and generates the reference input V15 based on the input values V5, V11 and V12.

The operation of the inverted control reference input generator 20 is described hereinafter with reference to FIG. 5. It is assumed that the reference input V1 that is transmitted from the direction input portion 10 to the reduction control execution portion 21 directs the robot 100 to accelerate up to a target speed with the speed as indicated by A. Assume now that a user feels anxiety and the user's pulse per unit time (which is referred to hereinafter simply as a pulse rate) increases in the process that the robot 100 accelerates up to the target speed in response to the reference input Vl. With an increase in the pulse of the user, a value of the pulse value V2 that is output from the pulse sensor 11 increases. The control portion 16 determines an anxiety level based on a comparison of the pulse value V2 with thresholds, searches the table based on the user ID and the anxiety level, and transfers the found reduction coefficient to the reduction control execution portion 21. The reduction control execution portion 21 modifies the descriptions of the reference input V1 according to the reduction coefficient value V4. Consequently, the motion of the robot 100 that accelerates up to the target speed with the speed as indicated by A is modified to accelerate up to the target speed over a longer time period than A, as indicated by B. It is thereby possible to eliminate the anxiety felt by the user. The reference input V1 may be modified according to the reduction coefficient value V4 by adopting a desired relational expression.

The angular speed sensor 25 measures an angular speed of the body 210. A specific configuration of the angular speed sensor 25 is arbitrary. For example, the angular speed sensor 25 has an angular speed sensor utilizing MEMS (Micro-Electro Mechanical Systems), converts an analog value output from the angular speed sensor into a digital value and outputs an angular speed value. The angular speed sensor 25 may be configured to detect the rotation in three directions along roll, pitch and yaw axes as an angular speed. The angle is calculated by integration of the angular speed. It is thereby possible to calculate a tilt of the body 210 with respect to the wheel 220.

The encoder 26 is made up of a pair of encoders respectively corresponding to the pair of wheels 220. The encoder corresponding to the right wheel measures a relative rotation amount of the right wheel and outputs a count value V 12 in accordance with the rotation amount. The same applies to the encoder corresponding to the left wheel. A specific configuration of the encoders is arbitrary. For example, any of optical and magnetic encoders may be adopted. In the case of using an optical encoder, the encoder optically measures the number of slits made in the peripheral area of a body of rotation placed on the wheel and outputs a count value corresponding to the number of slits. In the case of using a magnetic encoder, the encoder magnetically measures the number of magnets sequentially arranged in the peripheral area of a body of rotation described above and outputs a count value corresponding to the number of magnets.

The actuator 30 actuates the robot 100 based on the reference input V15. A specific operation is as follows.

The adder 31 generates a reference input V25 based on the reference input V15 and a torque value V20. Digital values such as the reference input V15 and the torque value V20 are added together by the adder 31 and become the reference input V25. The reference input V25 corresponds to a difference value between an absolute value of the reference input V15 and an absolute value of the torque value V20. The reference input V15 is calculated by ignoring the current torque generated in the motor 35. An intended torque can be generated by subtracting a torque value having a value corresponding to the current torque generated in the motor 35 from the reference input V15.

The motor amplifier 32 generates an actuation voltage having a value corresponding to the reference input V25 and outputs it to the motor 35. Because the reference input V25 is input in a temporally consecutive manner, a voltage waveform whose voltage value temporally varies is supplied from the motor amplifier 32 to the motor 35.

The motor 35 generates a power according to the input voltage waveform. The power generated by the motor 35 is supplied to the wheel 220.

The torque calculator 34 calculates a torque based on a current value measured in the shunt resistor 33 connected between the motor amplifier 32 and the motor 35. The torque calculator 34 outputs the calculated torque as the torque value V20 to the adder 31.

The operation of the robot 100 is described hereinafter with reference to FIG. 6.

First, a user ID is input (S500). Specifically, a user inputs a user ID to the ID input portion 12. In response to an input of the user ID by the user, the ID input portion 12 outputs the user ID value V3 to the control portion 16.

Next, the robot 100 comes into the inverted position (S501). Specifically, a user brings the robot 100 into the inverted position by operating an operator. The direction input portion 10 generates the reference input V1 according to the operation of the operator by the user. The robot 100 comes into the inverted position in response to the reference input V1. When the robot 100 is in the inverted position, the body 210 stands up along the vertical direction with respect to the wheel 220.

Then, a pulse rate is measured (S502). Specifically, the pulse sensor 11 measures the user's pulse per unit time and outputs the pulse value V2 having a value corresponding to the measured pulse rate to the control portion 16.

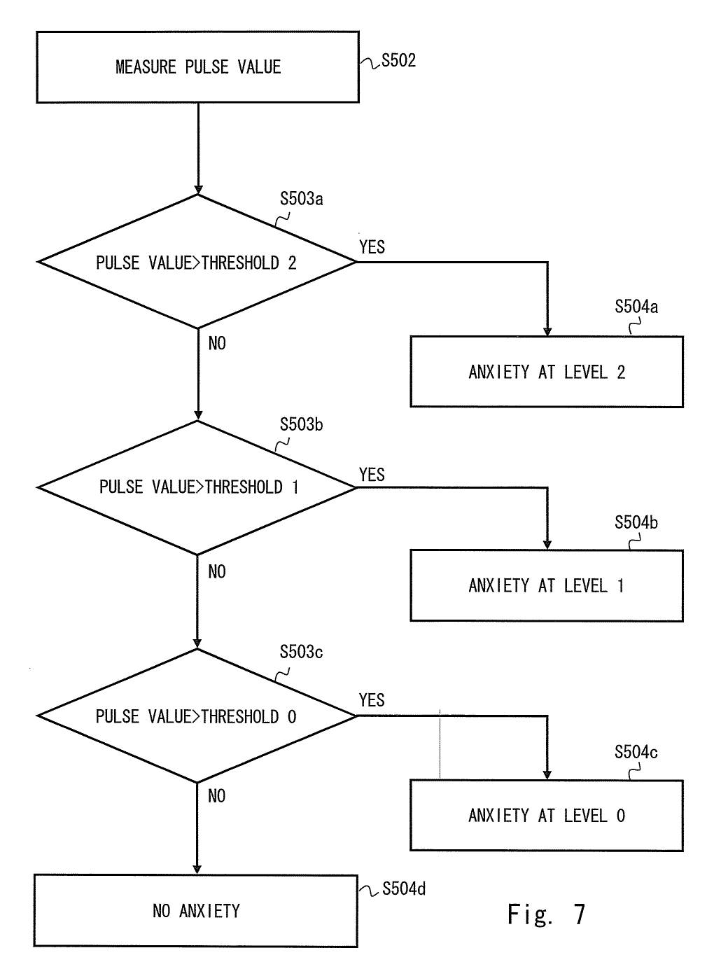

After that, the pulse rate is evaluated (S503). Specifically, the control portion 16 evaluates the pulse rate of the user based on the pulse value V2. A way of evaluating the pulse value V2 by the control portion 16 is described hereinbelow with reference to FIG. 7.

As a result of evaluating the pulse value, if it is estimated that the user has a feeling of anxiety, anxiety reduction processing is executed (S505). Specifically, the control portion 16 searches the table stored in the table storage portion 17 by using the anxiety level calculated by evaluating the pulse value and the user ID as a search key. The control portion 16 reads the value found by searching from the table stored in the table storage portion 17 and outputs the value as the reduction coefficient value V4 to the reduction control execution portion 21. The inverted control reference input generator 20 modifies the reference input V1 according to the reduction coefficient value V4 and generates the reference input V15 based on the reference input V5, the angular speed value V11 and the count value V12. In this manner, anxiety reduction control that reduces the anxiety felt by the user is executed. Specifically, as described above with reference to FIG. 5, the motion behavior of the robot 100 is modified to accelerate up to the target speed over a longer time period, thereby preventing the anxiety felt by the user from increasing.

After executing the anxiety reduction processing (S505), the control portion 16 returns to the step of evaluating the pulse value (S503). On the other hand, as a result of evaluating the pulse value, if it is not estimated that the user has a feeling of anxiety, the control portion 16 continues the step of evaluating the pulse value. Note that the pulse value of the user is output from the pulse sensor 11 at given time intervals.

Referring then to FIG. 7, a way of evaluating a pulse value by the control portion 16 is described hereinafter. Reference is made also to FIG. 3 as appropriate.

After measuring the pulse value (S502), the control portion 16 determines whether the pulse value V2 exceeds the threshold 2 or not (S503a). If the pulse value V2 is more than the threshold 2, the control portion 16 determines that the anxiety level of the user is 2(S504a).

Next, the control portion 16 determines whether the pulse value V2 exceeds the threshold 1 or not (S503b). If the pulse value V2 is more than the threshold 1, the control portion 16 determines that the anxiety level of the user is 1(S504b).

Further, the control portion 16 determines whether the pulse value V2 exceeds the threshold 0 or not (S503c). If the pulse value V2 is more than the threshold 0, the control portion 16 determines that the anxiety level of the user is 0(S504c).

If the pulse value V2 is equal to or less than the threshold 0, the control portion 16 determines that the user does not have a feeling of anxiety(S504d).

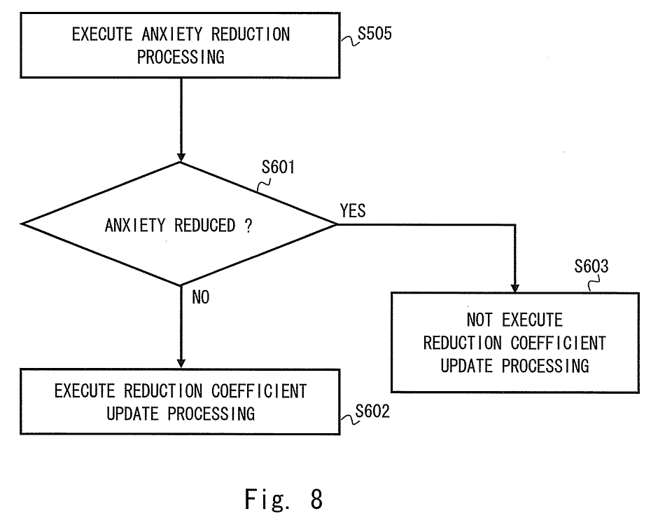

Referring then to FIG. 8, table update control which is executed by the control portion 16 is described. Note that the table update control is activated by selection of a user, for example.

First, the anxiety reduction processing which is described above in the step S505 of FIG. 6 is executed.

Next, it is determined whether the anxiety of the user is reduced by the anxiety reduction processing in the step S505 (S601). Specifically, it is determined whether the pulse rate of the user after a given time period becomes equal to or less than a predetermined threshold. To be specific, the control portion 16 starts measuring time from the point of outputting the reduction coefficient value V4 and determines whether the pulse value V2 obtained after the given time period becomes equal to or less than the predetermined threshold.

As a result of the step S601, if the pulse value is not equal to or less than the predetermined threshold, the reduction coefficient is updated (S602). Specifically, the control portion 16 accesses the table stored in the table storage portion 17 and increases the value of the reduction coefficient associated with the current user ID. For example, the control portion 16 increases each reduction coefficient associated with the user ID of 0002 to 1.5 times as shown in FIG. 4. On the other hand, if, as a result of the step S601, the pulse value is equal to or less than the predetermined threshold, the reduction coefficient is not updated (S603).

In the case shown in FIG. 4, the reduction coefficients associated with the user ID of 0001 are initial values. The reduction coefficients associated with the user ID of 0002 are updated by the above-described update processing.

In this exemplary embodiment, the reduction coefficient is updated according to a time period to overcome a feeling of anxiety which is different between users. It is thereby possible to achieve anxiety reduction control appropriate for each individual user. Note that the reduction coefficient is not necessarily updated automatically by the robot 100, and the reduction coefficient may be updated based on an intention of a user. Specifically, the reduction coefficient is not a fixed value but is decided in accordance with each individual user.

As is obvious from the above description, in this exemplary embodiment, the motion behavior of the robot 100 on the basis of the reference input V1 is modified according to the pulse value V2 measured by the pulse sensor 11. Specifically, the pulse value V2 is evaluated, the reduction coefficient is determined according to the evaluation result, the descriptions of the reference input V1 are modified according to the determined reduction coefficient, and the reference input V15 is generated based on the reference input V5 after modification, the angular speed value V11 and the count value V12. It is thereby possible to modify the motion behavior of the robot 100 on the basis of the reference input V1 so as to reduce the anxiety of a user. For example, when the robot 100 accelerates suddenly and a user feels anxiety, the acceleration of the robot 100 is reduced after that, thereby effectively preventing the anxiety of the user from increasing.

Further, in this exemplary embodiment, the state of mind of a user is estimated based on measurement of the physical state of the user (measurement of the pulse rate of the user). In other words, the state of mind of a user is estimated based on acquisition of biological information of the user. A change in the state of mind of a user is detected immediately by measuring the physical state of the user, thereby providing feedback to the motion of the robot 100 in the form of anxiety reduction control.

Furthermore, in this exemplary embodiment, reduction coefficients are prepared in the table in advance, and a reduction coefficient can be retrieved based on the pulse value. It is thereby possible to generate the reduction coefficient quickly and supply it to the reduction control execution portion 21.

Further, in this exemplary embodiment, the pulse rate is evaluated with a plurality of thresholds, and the degree of anxiety felt by a user is calculated as the anxiety level. Then, a reduction coefficient is retrieved based on the anxiety level. It is thereby possible to reduce the amount of data to be stored in the table to a necessary minimum. It is also possible to execute anxiety reduction control in a practically necessary range.

Furthermore, in this exemplary embodiment, reduction coefficients are stored in association with user IDs. It is thus possible to set a reduction coefficient with a value appropriate for each user. Particularly, in this exemplary embodiment, the value of a reduction coefficient is updated so that anxiety reduction control becomes more effective according to a reaction of each user to anxiety reduction control by the learning function of the robot 100. Therefore, by continuing use of the robot 100, each robot 100 becomes able to execute anxiety reduction control suitable for each user.

### Second Exemplary Embodiment

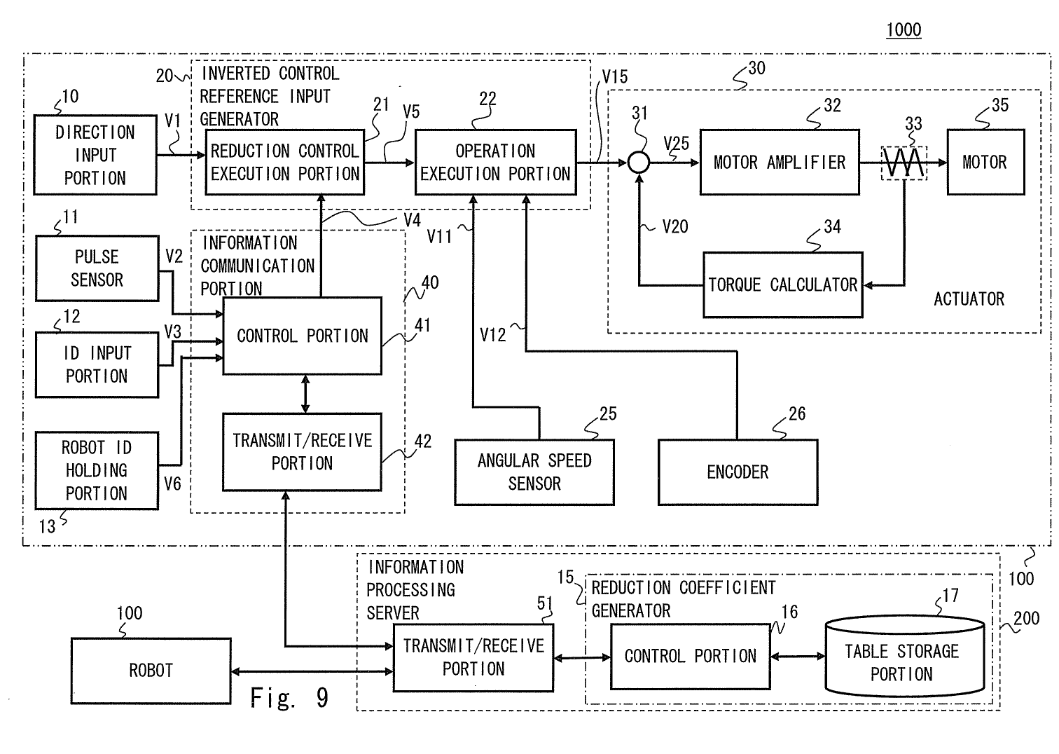

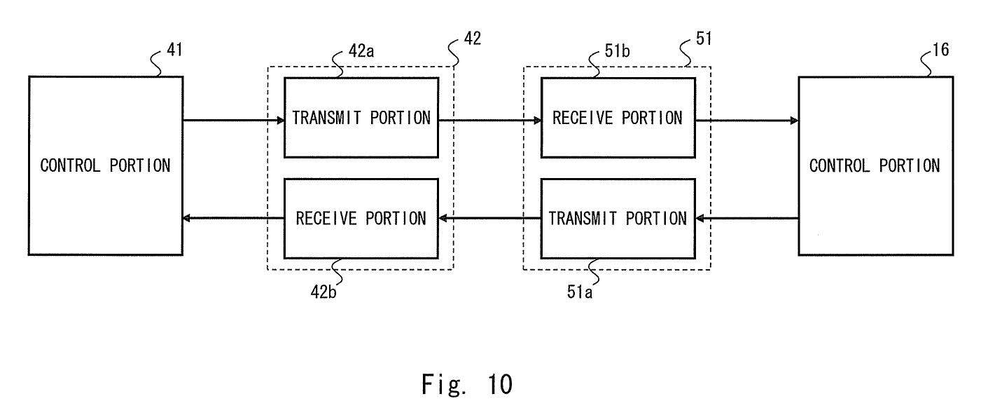

A second exemplary embodiment of the present invention is described hereinafter with reference to FIGS. 9 and 10. FIG. 9 is a schematic block diagram of an inverted two-wheeled robot. FIG. 10 is a schematic block diagram of a transmit/receive portion in the inverted two-wheeled robot.

Referring to FIG. 9, a system 1000 includes a plurality of robots 100 and an information processing server 200. In this exemplary embodiment, the reduction coefficient generator 15, which has been placed in the robot 100 in the first exemplary embodiment, is integrated into the information processing server 200. It is thereby possible to share the reduction coefficient for each user that is held in each robot 100.

As shown in FIG. 9, the robot 100 includes a robot ID holding portion 13 and an information communication portion 40. The information communication portion 40 includes a control portion 41 and a transmit/receive portion 42. The information processing server 200 includes a transmit/receive portion 51 and the reduction coefficient generator 15.

An output terminal of the pulse sensor 11 is connected to the control portion 41. An output terminal of the ID input portion 12 is connected to the control portion 41. An output terminal of the robot ID holding portion 13 is connected to the control portion 41. An output of the control portion 41 is supplied to the reduction control execution portion 21. An input/output terminal of the control portion 41 is connected to an input/output terminal of the transmit/receive portion 42. The transmit/receive portion 42 and the transmit/receive portion 51 are connected over a radio line. An input/output terminal of the transmit/receive portion 51 is connected to an input/output terminal of the control portion 16.

The robot ID holding portion 13 holds robot IDs (identification values) assigned to the respective robots 100. The robot ID holding portion 13 is nonvolatile memory (ROM) or hard disk (HDD) inside the robot. A robot ID value V6 is supplied from the robot ID holding portion 13 to the control portion 41.

The control portion 41 transmits the pulse value V2, the user ID value V3 and the robot ID value V6 to the information processing server 200 through the transmit/receive portion 42. The control portion 16 receives the values transmitted from the robot 100 through the transmit/receive portion 51. The control portion 16 evaluates the pulse value V2 in the same manner as in the first exemplary embodiment. Then, the control portion 16 searches the table by using an anxiety level value determined from the evaluation result and the user ID value as a search key. The control portion 16 reads a reduction coefficient which is found by searching the table from the table storage portion 17. The control portion 16 then transmits the read reduction coefficient and the temporarily held robot ID value to the robot 100 through the transmit/receive portion 51. Note that the control portion 16 has a holding area that temporarily holds a robot ID value.

The control portion 41 determines whether the robot ID value received from the information processing server 200 through the transmit/receive portion 42 matches the robot ID value held in the robot ID holding portion 13. If the both values match, the control portion 41 supplies the reduction coefficient value received together with the robot ID value to the reduction control execution portion 21. The operation of the reduction control execution portion 21 is the same as described in the first exemplary embodiment.

With the above-described mechanism, it is possible to obtain the same advantage as that of the first exemplary embodiment in this exemplary embodiment.

As shown in FIG. 10, the transmit/receive portion 42 includes a transmit portion 42a and a receive portion 42b. The transmit/receive portion 51 includes a transmit portion 51a and a receive portion 51b. An output of the transmit portion 42a is supplied to the receive portion 51b. An output of the transmit portion 51a is supplied to the receive portion 42b. A specific means of radio transmission is arbitrary. For example, wireless communication between the robot 100 and the information processing server 200 may be implemented by radio waves. Instead of radio wave communication, optical communication may be employed. Further, the robot 100 and the information processing server 200 may be connected for communication by wired communication, not wireless communication.

As is obvious from the above description, in this exemplary embodiment, the reduction coefficient generator 15, which has been placed in each individual robot 100, is integrated into the information processing server 200. It is thereby possible to simplify the structure of each robot 100 and reduce the cost. It is further possible to reduce the cost of a system that needs a large number of robots 100. Further, the same advantage as that of the first exemplary embodiment can be obtained in this case as well.

### Third Exemplary Embodiment

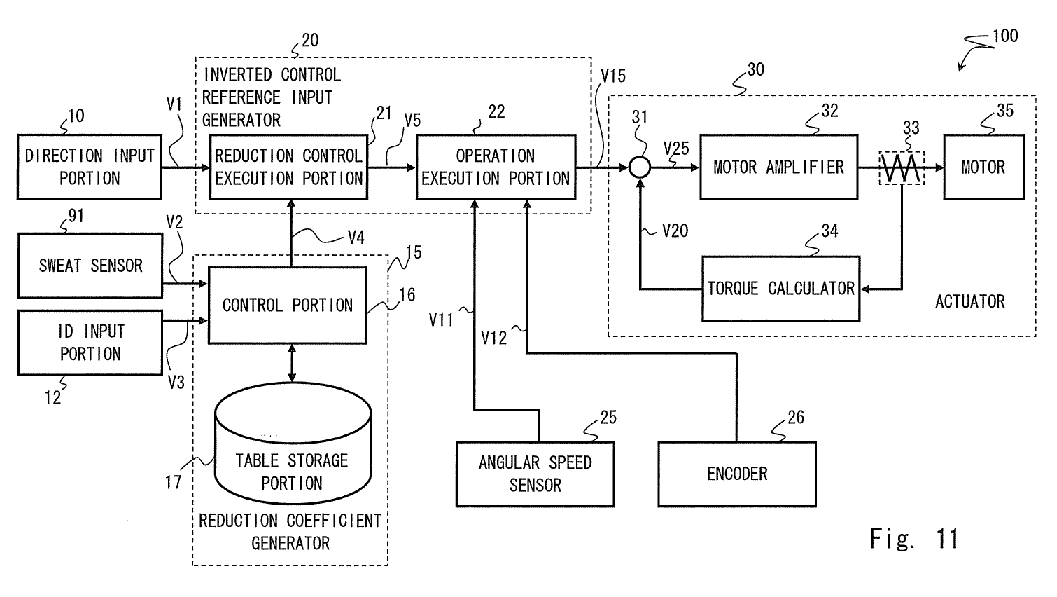

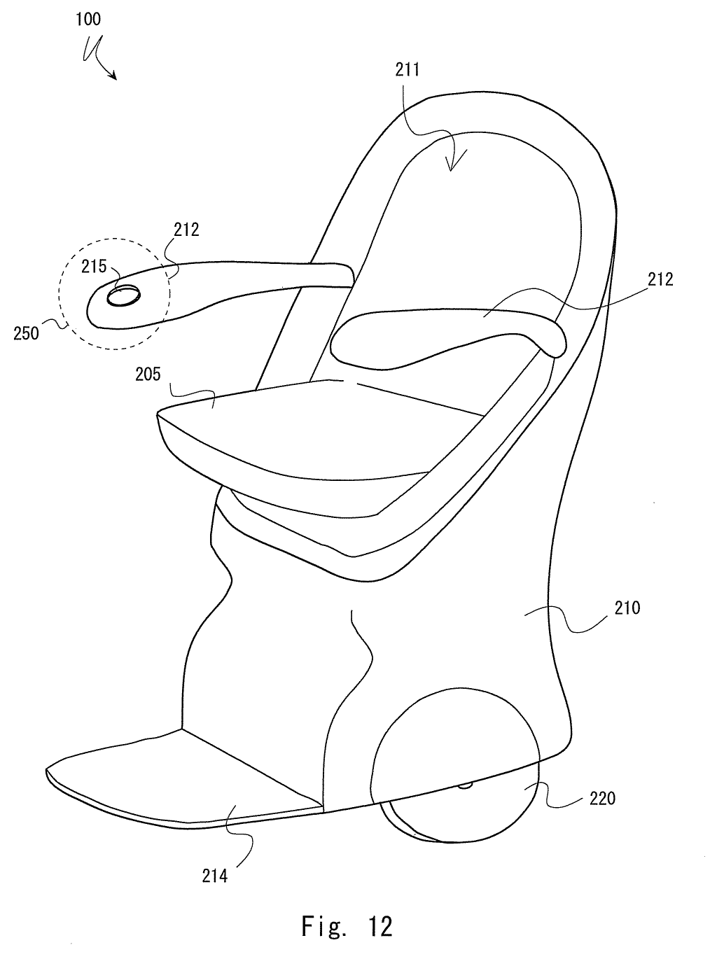

A third exemplary embodiment of the present invention is described hereinafter with reference to FIGS. 11 and 12. FIG. 11 is a schematic block diagram of an inverted two-wheeled robot. FIG. 12 is a schematic perspective view of the inverted two-wheeled robot.

In this exemplary embodiment, differently from the first exemplary embodiment, the amount of sweating of a user is measured instead of the pulse of a user. In such a case also, the same advantage as that of the first exemplary embodiment can be obtained. A specific technique of anxiety reduction control is the same as described in the first exemplary embodiment.

Referring to FIG. 11, the robot 100 includes a sweat sensor (sensor) 91. An output terminal of the sweat sensor 91 is connected to the control portion 16. The sweat sensor 91 measures the amount of sweating by an arbitrary means. For example, the amount of sweating may be measured by using a humidity sensor. Alternatively, a ventilating capsule sweat meter, a dermometer or the like may be used.

It is preferred to place the sweat sensor 91 in the vicinity of the ball controller 215 where a user's body is exposed to the outside as indicated by a dashed line 250 of FIG. 12. Alternatively, the sensor unit 213 similar to that of FIG. 1 may be employed.

### Fourth Exemplary Embodiment

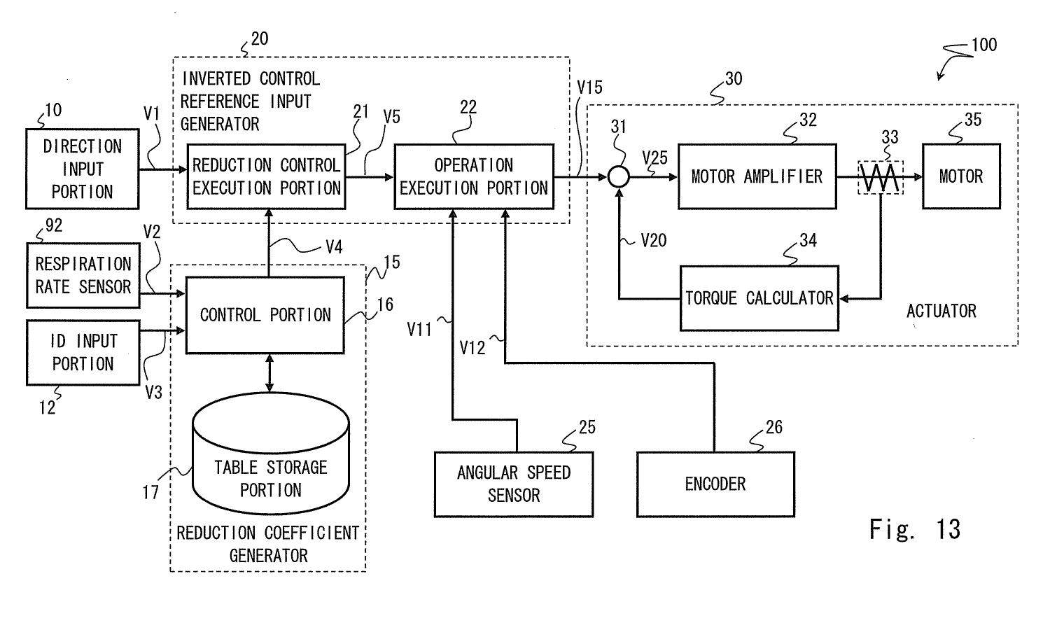

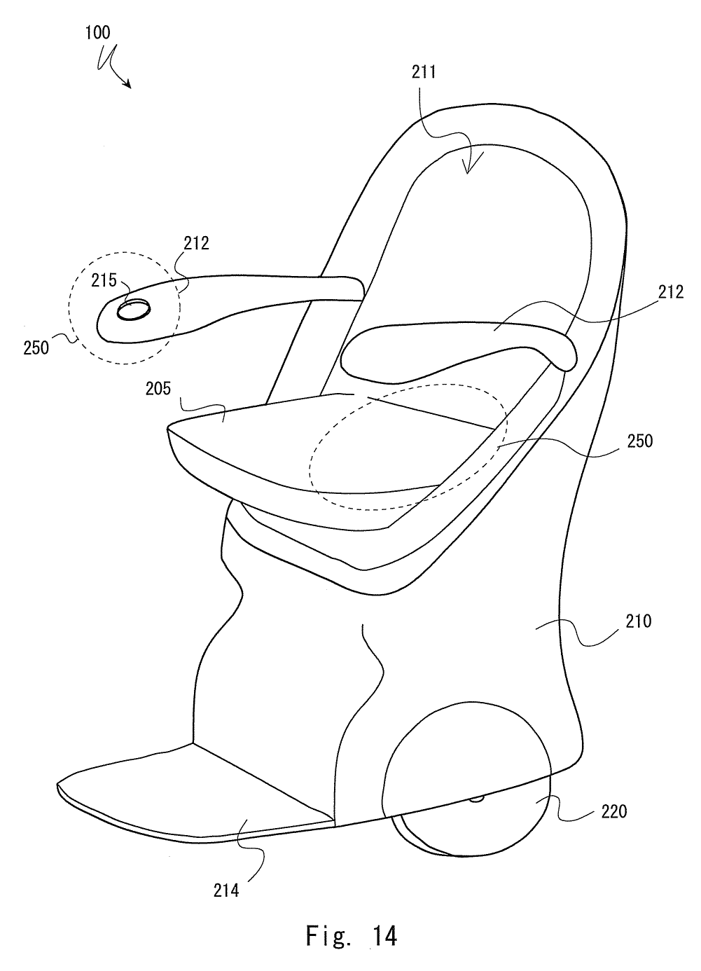

A fourth exemplary embodiment of the present invention is described hereinafter with reference to FIGS. 13 and 14. FIG. 13 is a schematic block diagram of an inverted two-wheeled robot. FIG. 14 is a schematic perspective view of the inverted two-wheeled robot.

In this exemplary embodiment, differently from the first exemplary embodiment, the rate of respiration of a user is measured instead of the pulse of a user. In such a case also, the same advantage as that of the first exemplary embodiment can be obtained. A specific technique of anxiety reduction control is the same as described in the first exemplary embodiment.

Referring to FIG. 13, the robot 100 includes a respiration rate sensor (sensor) 92. An output terminal of the respiration rate sensor 92 is connected to the control portion 16. The respiration rate sensor 92 measures the rate of respiration by an arbitrary means. For example, the rate of respiration may be measured by measuring the micro-vibration of a user. In this case, it is preferred to place a pressure sensor in an area where a user comes into contact with the robot 100 and measure the respiration rate of the user based on an output of the pressure sensor.

It is preferred to place the respiration rate sensor 92 in the vicinity of the ball controller 215 where a user comes into contact with the robot 100 as indicated by a dashed line 250 of FIG. 14. It is also feasible to place the respiration rate sensor 92 in the sear area where a user comes into contact with the robot 100.

### Fifth Exemplary Embodiment

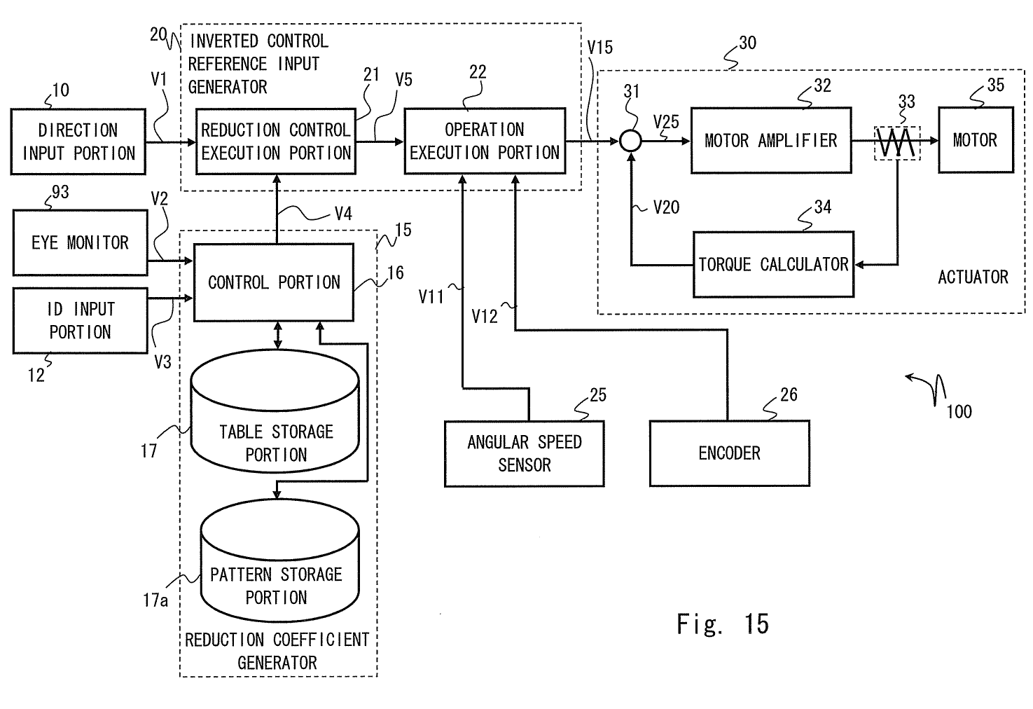

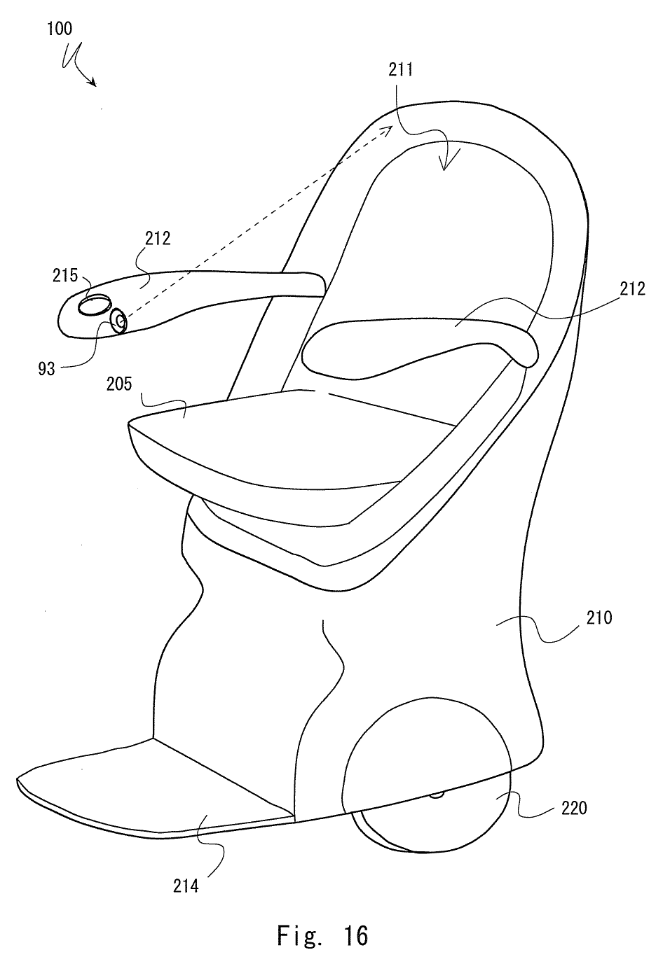

A fifth exemplary embodiment of the present invention is described hereinafter with reference to FIGS. 15 and 16. FIG. 15 is a schematic block diagram of an inverted two-wheeled robot. FIG. 16 is a schematic perspective view of the inverted two-wheeled robot.

In this exemplary embodiment, differently from the first exemplary embodiment, the eye movement of a user is observed, and the user's feeling of anxiety is measured based on whether a particular eye movement is detected or not. In such a case also, the same advantage as that of the first exemplary embodiment can be obtained.

Referring to FIG. 15, the robot 100 includes an eye monitor 93 and a pattern storage portion 17a. The eye monitor 93 obtains the locus of the eye from sequentially captured images and outputs the obtained data to the control portion 16. The control portion 16 determines whether the eye movement locus obtained at this time in the eye monitor 93 indicates the anxiety of the user based on movement locus information stored in the pattern storage portion 17a.

A specific means of determining pattern match or mismatch is arbitrary. For example, a pattern to be compared is divided into a plurality of parts, and if the proportion of matching parts is equal to or more than a predetermined value, it is determined that the pattern matches. The control portion 16 calculates the anxiety level of a user based on a value calculated in the process of determining pattern match or mismatch. It is the same as in the first exemplary embodiment to calculate the reduction coefficient based on the anxiety level and the user ID.

As shown in FIG. 16, it is preferred to place the eye monitor 93 at the position from which the user's eye can be imaged. It is preferred to use a general image sensor such as a CCD image sensor or a CMOS image sensor is preferably used as an image pickup element of the eye monitor 93.

### Sixth Exemplary Embodiment

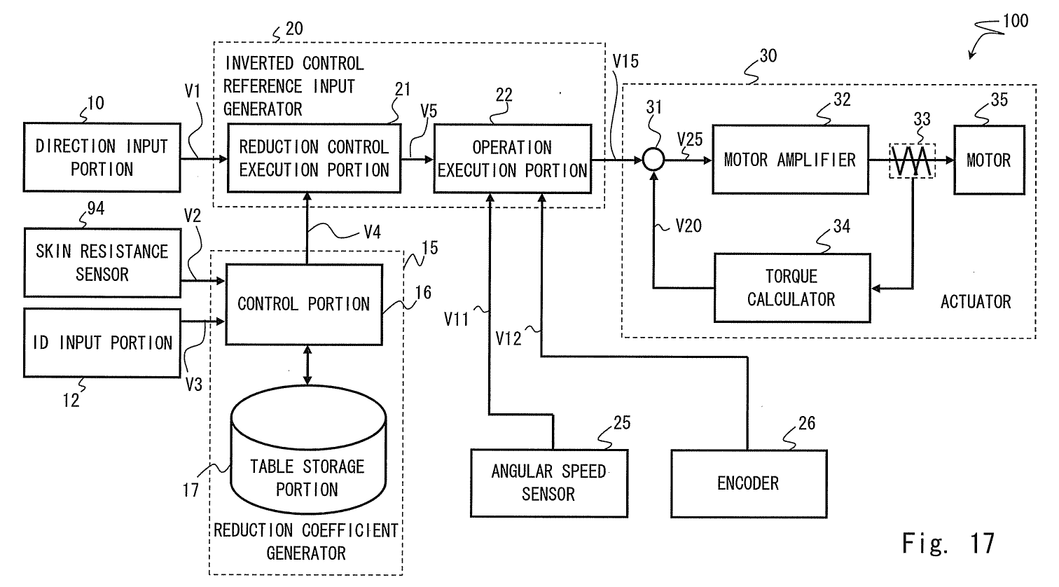

A sixth exemplary embodiment of the present invention is described hereinafter with reference to FIG. 17. FIG. 17 is a schematic block diagram of an inverted two-wheeled robot.

In this exemplary embodiment, differently from the first exemplary embodiment, the skin resistance of a user is measured instead of the pulse of a user. In such a case also, the same advantage as that of the first exemplary embodiment can be obtained. A specific technique of anxiety reduction control is the same as described in the first exemplary embodiment.

Referring to FIG. 17, the robot 100 includes a skin resistance sensor (sensor) 94. An output terminal of the skin resistance sensor 94 is connected to the control portion 16. The skin resistance sensor 94 measures the skin resistance of a user by an arbitrary means. For example, the feeling of anxiety of a user may be measured by bringing a pair of sensing electrodes into contact with the skin of the user and measuring a weak current flowing between the sensing electrodes. It is assumed that a user has a feeling of anxiety when the measured current value decreases.

A means of attaching the skin resistance sensor 94 to a user is arbitrary. For example, a sensor part may be attached to the skin (e.g. hand skin) of a user by employing the same means as in the first exemplary embodiment.

### Seventh Exemplary Embodiment

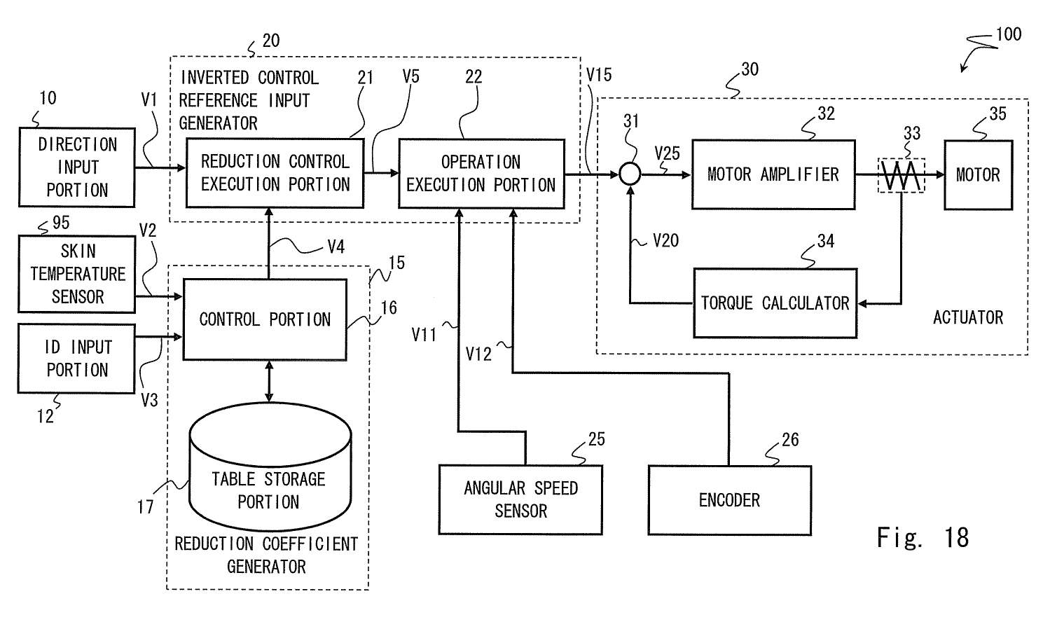

A seventh exemplary embodiment of the present invention is described hereinafter with reference to FIG. 18. FIG. 18 is a schematic block diagram of an inverted two-wheeled robot.

In this exemplary embodiment, differently from the first exemplary embodiment, the skin temperature of a user is measured instead of the skin pulse of a user. In such a case also, the same advantage as that of the first exemplary embodiment can be obtained. A specific technique of anxiety reduction control is the same as described in the first exemplary embodiment.

Referring to FIG. 18, the robot 100 includes a skin temperature sensor (sensor) 95. An output terminal of the skin temperature sensor 95 is connected to the control portion 16. The skin temperature sensor 95 measures the skin temperature of a user by an arbitrary means. For example, a sensing electrode of a thermistor may be attached to the skin of a user. It is assumed that a user has a feeling of anxiety when the skin temperature decreases.

A means of attaching the skin temperature sensor 95 to a user is arbitrary. For example, a sensor part may be attached to the skin (e.g. hand skin) of a user by employing the same means as in the first exemplary embodiment.

### Eighth Exemplary Embodiment

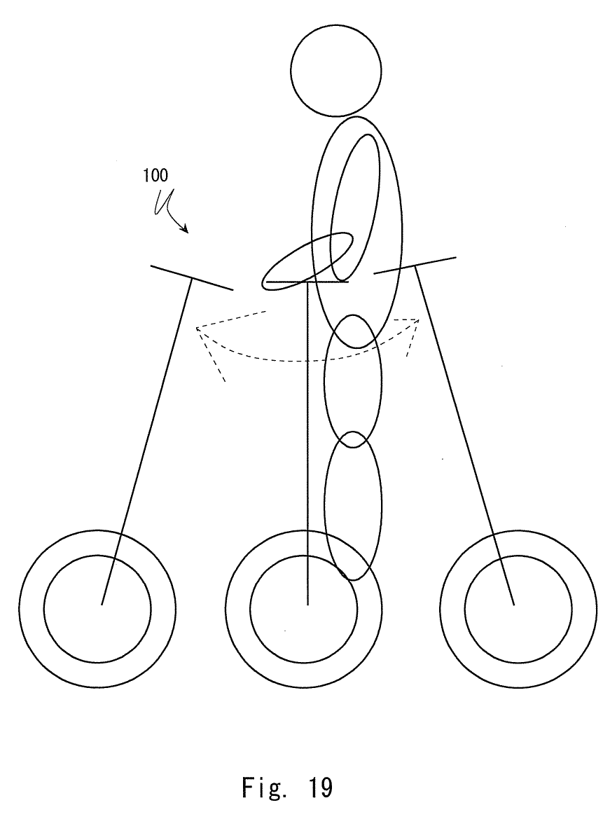

An eighth exemplary embodiment of the present invention is described hereinafter with reference to FIG. 19. FIG. 19 is a schematic explanatory view showing the motion of an inverted two-wheeled robot. A specific technique of anxiety reduction control is the same as described in the first exemplary embodiment.

In this exemplary embodiment, the inverted control reference input generator 20 moves back and forth like a cradle as shown in FIG. 19 when the following two conditions are satisfied.

The first condition is that the robot 100 is stopping with the inverted position. This can be calculated from outputs of the angular speed sensor 25 and the encoder 26. The second condition is when the control portion 16 transmits a reduction coefficient. In this case, it can be estimated that a user feels anxiety not about the motion of the robot 100 based on the user's own operation direction but about being on board the robot 100 in the inverted position.

In this exemplary embodiment, the inverted control reference input generator 20 swings like a cradle as shown in FIG. 19 when the above conditions are satisfied as described above. It is thereby possible to reduce the anxiety of a user being on board the robot 100. It should be noted that any motion may be produced as long as it reduces the user's feeling of anxiety, and it is not limited to the motion like a cradle. Further, it is arbitrary to generate swinging of what extent at what time intervals.

The swinging motion may be executed while monitoring the anxiety of a user. For example, the pulse value that is output from the pulse sensor 11 is supplied to the reduction control execution portion 21 through the control portion 16. The reduction control execution portion 21 monitors the transferred pulse value and detects the condition under which the pulse value becomes the lowest in the process of increasing and decreasing the swing speed. With use of such a mechanism, it is possible to detect the condition most suitable for the current user. The detected condition may be stored in association with a user ID as appropriate. Further, the optimum value of the extent of swinging (the amount of the back and forth rotation of the wheels) may be found.

### Ninth Exemplary Embodiment

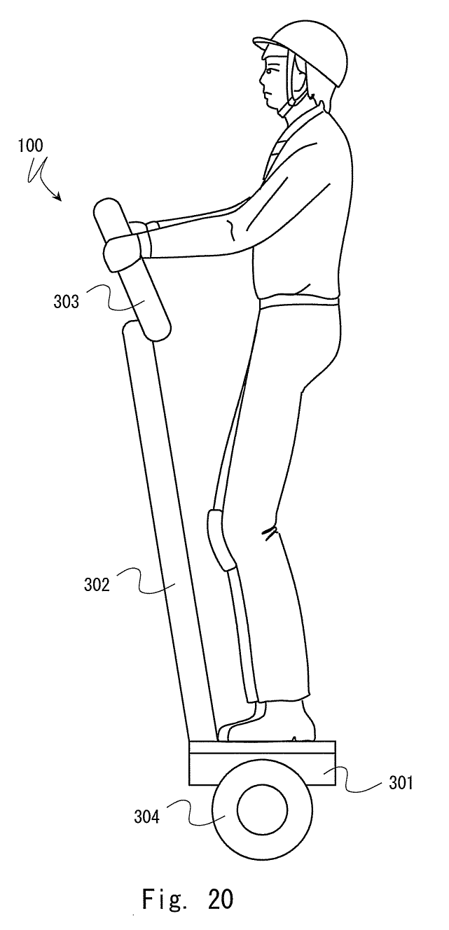

A ninth exemplary embodiment of the present invention is described hereinafter with reference to FIG. 20. FIG. 20 is a schematic side view of an inverted two-wheeled robot.

As shown in FIG. 20, the robot 100 according to the exemplary embodiment is a different type from those described in the above exemplary embodiments. In such a case also, the same advantage as that of the first exemplary embodiment can be obtained. Specific hardware and software structures in the robot are the same as those described in the above exemplary embodiments.

Referring to FIG. 20, the robot 100 includes a base 301, an extension frame 302, a handle 303 and a wheel 304. The base 301, the extension frame 302 and the handle 303 constitute a main body. A user stands on the base 301, grips the handle 303 and maneuvers the robot 100. As an operator of the robot 100, a ball controller may be adopted as in the above exemplary embodiments. Alternatively, another operator such as handle with a button indicating the direction of movement may be adopted. The appearance and other specific structures of the robot 100 are arbitrary.

It should be noted that the present invention is not restricted to the above-described exemplary embodiments, and various changes and modifications may be made without departing from the scope of the invention. The above-described exemplary embodiments are not independent of one another, and they can be combined as desirable, which exerts a synergetic effect. The above-described functional blocks (the reduction coefficient generator, the inverted control reference input generator) may be implemented by producing a logic with use of hardware in advance such as a wired logic. Those functional blocks may be implemented by software control. Specifically, the functional blocks may be realized by executing a program on a CPU.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A vehicle that executes motion by modifying a motion behavior on the basis of a motion direction of a user on board according to a state of mind of the user on board.

2. The vehicle according to claim 1, comprising:
a direction input portion that receives the motion direction from the user and generates a reference input corresponding to the motion direction; and
a motion reference input generator that generates a motion reference input that makes the vehicle execute motion in a behavior different from the motion behavior on the basis of the motion direction, based at least on a state value with a value corresponding to the state of mind of the user and the reference input generated in the direction input portion.

3. The vehicle according to claim 2, wherein the state value is determined based on measurement of a physical state of the user on board.

4. The vehicle according to claim 2, further comprising:
a sensor that measures a physical state of the user on board; and
a state value generator that generates the state value based on an output of the sensor.

5. The vehicle according to claim 4, wherein the state value generator generates the state value based on an evaluation value generated by evaluating the physical state of the user measured by the sensor.

6. The vehicle according to claim 5, wherein the state value generator generates the state value based on an identification value assigned to each user in addition to the evaluation value.

7. The vehicle according to claim 6, wherein the state value generator searches for information by using the evaluation value and the identification value as a search key and sets a value found by searching to the state value.

8. The vehicle according to claim 4, wherein the state value generator reevaluates the physical state of the user when the vehicle is executing motion by modifying the motion behavior on the basis of the motion direction of the user, and updates a value of the state value generated by the state value generator under identical conditions based on the reevaluation result.

9. The vehicle according to claim 4, wherein the motion reference input generator generates a motion reference input for making the vehicle execute motion to improve the state of mind of the user when the state value is generated by the state value generator during a period when the vehicle is not moving.

10. The vehicle according to claim 1, wherein the vehicle is a vehicle that moves through a space with a position of a body relative to a wheel being controlled.

11. The vehicle according to claim 10, further comprising:
an angular speed sensor that measures an angular speed of the body; and
a measuring portion that measures a change in a relative position between the body and the wheel in a rotating direction of the wheel, wherein
the motion reference input generator generates the motion reference input based on the state value, the reference input generated in the direction input portion, an output of the angular speed sensor, and an output of the measuring portion.

12. A system comprising:
a plurality of vehicles each including a direction input portion that receives a motion direction from a user and generates a reference input corresponding to the motion direction, and a sensor that measures a physical state of the user on board; and
an information processing device connected for communicating with each of the plurality of vehicles in an identifiable manner, wherein
the information processing device generates a state value with a value corresponding to a state of mind of the user based an output of the sensor, and
each vehicle executes motion by modifying a motion behavior on the basis of the motion direction based at least on the state value transmitted from the information processing device to the vehicle and the reference input generated in the direction input portion.

13. A vehicle motion producing method comprising:
measuring a physical state of a user on board a vehicle in order to estimate a state of mind of the user; and
modifying a motion behavior of the vehicle on the basis of a motion direction directed to the vehicle by the user according to a measurement result of the physical state of the user.

14. A non-transitory computer readable medium storing a program causing a computer to execute a process that modifies a motion behavior of a vehicle on the basis of a motion direction directed to the vehicle by a user on board the vehicle according to a measurement result of a physical state of the user.
